(19) United States
(12) Patent Application Publication
(10) Pub. No.: US 2018/0284852 A1
(43) Pub. Date: Oct. 4, 2018

(54) SYSTEMS AND STRUCTURES FOR POSITIONING HEAT SINKS AND/OR OTHER DEVICES IN RELATION TO PROCESSORS AND/OR OTHER COMPONENTS ON PRINTED CIRCUIT BOARDS AND OTHER STRUCTURES

(71) Applicant: Silverdraft Supercomputing, LLC, Boise, ID (US)

(72) Inventors: Randy K. Rannow, Boise, ID (US); Erik Smith, Boise, ID (US)

(21) Appl. No.: 15/476,624

(22) Filed: Mar. 31, 2017

(51) Int. Cl. G06F 1/20; F16M 13/02

(52) U.S. Cl. CPC G06F 1/20; F16M 13/02

(57) ABSTRACT

Adapters are described herein for accurately mounting a first component or device to a second component or device in a computer or other system. In some embodiments, the adapters comprise a structural beam member that bridges a variable gap across an opening in a bracket or other component to secure the bracket to an underlying substrate (e.g., a PCB) or other piece of hardware. The adapters may have a cross-sectional shape to provide a desired stiffness, and can have a variety of planform shapes (e.g., trapezoidal or rectangular shapes) that enable the adapter to be fitted to the mounting structure with sufficient clearance to adjacent hardware and features to enable the adapters to be used without structurally modifying existing hardware. Additionally, embodiments of the adapters described herein can allow the lateral positioning of mounting bracketry to be adjusted for proper alignment of interfacing components prior to attachment. Additionally, various embodiments of the adapters described herein also provide the ability to adjust the pressure or force between two contacting surfaces to meet design and performance requirements.

### TECHNICAL FIELD

The present disclosure is generally related to structures for adjustably mounting thermal management apparatuses and/or other components to CPUs, ASICs, FPGAs and/or other devices on printed circuit boards, sockets and other structures.

### BACKGROUND

Today's computer systems often include high performance processing devices (e.g., CPUs and GPUs) that operate at very high core frequencies and power requirements, which in turn can generate a substantial amount of heat. As a result, device performance is often limited by the amount of heat that can be extracted from the device during operation. Effective heat removal solutions are particularly necessary in high performance or high device utilization applications and environments. These solutions, however, need to be highly reliable and readily adaptable for use with a wide variety of processing modules.

Some processing modules (e.g., graphics cards) are not supplied with a dedicated cooling system, while others may include a stock heatsink or other cooling system that may not be adequate to meet the demands of high performance computing environments. By way of example, some graphics cards are provided with a conventional cooling system consisting of a fan and a GPU heat sink that mount directly to the graphics card. While this system may be adequate for some applications, it may be unable to provide the level of cooling necessary for high device utilization. As a result, some aftermarket manufacturers provide cooling solutions (such as liquid cooling solutions) that are intended to increase device performance and be compatible with a variety of commercially available graphics cards. Often, however, these “off-the-shelf” solutions may not be thoroughly vetted for compatibility or interoperability with a particular graphics card, which renders them unusable or instead forces the equipment integrator to rework the off-the-shelf solution so that it can work properly with a particular graphics card.

While many of the cooling solutions currently offered for use with graphics cards and other high performance processing devices are advertised as being fully compatible and relatively easy to install in place of stock heatsinks, in practice many of these solutions are incompatible with the graphics card without significant modification. As a result, such systems can be difficult to use at best, and may also compromise device performance. Accordingly, it would be advantageous to provide a system that would enable computer system equipment integrators to easily fit a desired aftermarket high performance cooling solution to a graphics card or other processing module in place of the existing heatsink to increase device performance in a cost effective manner.

### BRIEF DESCRIPTION OF THE DRAWINGS

FIG. 1A is a partially exploded isometric view of a cooling system for use with a processing module, and FIG. 1B is an isometric view illustrating a bracket of the cooling system positioned on the processing module.

FIG. 2 is a partially exploded isometric view of a cooling system with a plurality of universal adapters for mounting the cooling system to a processing module in accordance with an embodiment of the present technology.

FIG. 3A is a top view of the cooling system bracket of FIG. 2 mounted to the processing module with the adapters of the present technology; FIGS. 3B and 3C are cross-sectional views taken along line 3B-3B in FIG. 3A; and FIG. 3D is an isometric view showing the cooling system of FIG. 2 mounted to the processing module with the adapters of the present technology.

FIGS. 4A-4C are a series of cross-sectional views illustrating various aspects of mounting adapters configured in accordance with embodiments of the present technology.

FIGS. 5A and 5B are top and side views, respectively, of a mounting adapter configured in accordance with an embodiment of the present technology, and FIG. 5C is a side view of a mounting adapter configured in accordance with another embodiment of the present technology.

### DETAILED DESCRIPTION

The following disclosure describes various embodiments of adapters and associated hardware assemblies for positioning one operational device (e.g., a heat sink) in a mechanical, electrical, optical, and/or thermal relationship to another operational device (e.g., a processing device) in a computer or other system. For example, the adapters described herein can be used to mount a thermal management apparatus, such as an aftermarket cooling system, to an ASIC, FPGA, CPU, GPU, or other electronic device where there are space constraints or the presence of physical features that prohibit or at least greatly complicate the use of the mounting hardware provided with the cooling system. Additionally, in some embodiments the adapters described herein enable a heatsink (or other device) to be positioned in contact with a GPU or other electronic package with a controlled force, and in a manner that facilitates lateral adjustment of the heatsink relative to the electronic package. As described in greater detail below, in some embodiments the adapters described herein can be in the form of a structural member, such as a beam, that bridges a variable gap across an opening in, e.g., a mounting bracket to adjustably attach the bracket and a corresponding heatsink or other thermal apparatus to a processing device. In some embodiments, the adapter can be referred to as a “universal adapter” (or bracket, fitting, etc.) by virtue of it being readily usable to facilitate attachment of a wide variety of cooling systems and/or other hardware to various types of processing modules and/or other computer system components. As noted above, in many cases aftermarket cooling system mounting hardware that is advertised as being “compatible” with certain graphics cards and other processing modules is in fact incompatible because of manufacturing tolerances and/or other factors that prevent proper installation. Accordingly, embodiments of the brackets described herein can enable these otherwise incompatible cooling systems to be easily integrated and mounted to the intended processing modules in a cost effective and reliable manner.

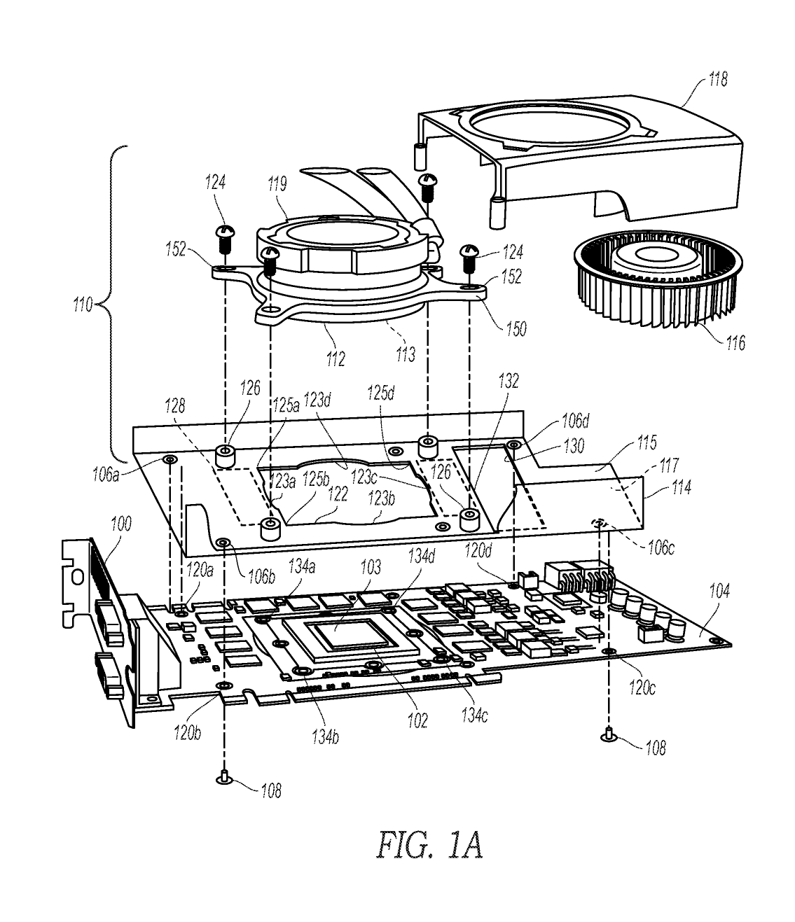

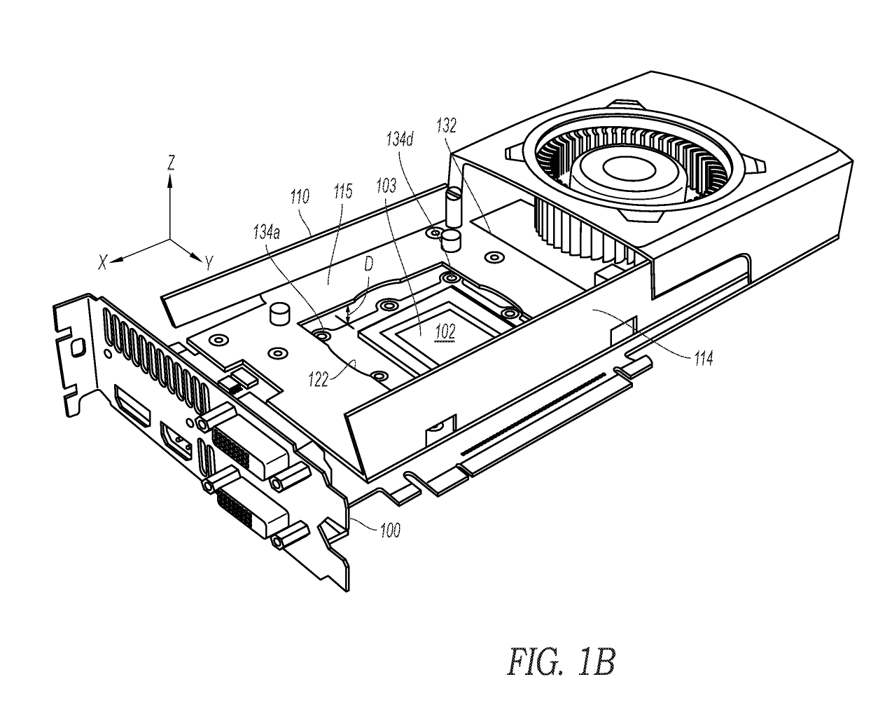

Certain details are set forth in the following description and in FIGS. 1-5C to provide a thorough understanding of various embodiments of the present technology. In other instances, well-known structures, materials, operations and/or systems often associated with Printed Circuit Boards, CPUs, GPUs and other processing devices, heat sinks, liquid cooling systems and other thermal control apparatuses, etc., are not shown or described in detail in the following disclosure to avoid unnecessarily obscuring the description of the various embodiments of the technology. Those of ordinary skill in the art will recognize, however, that the present technology can be practiced without one or more of the details set forth herein, or with other structures, methods, components, and so forth.

The terminology used below is to be interpreted in its broadest reasonable manner, even though it is being used in conjunction with a detailed description of certain examples of embodiments of the technology. Indeed, certain terms may even be emphasized below; however, any terminology intended to be interpreted in any restricted manner will be overtly and specifically defined as such in this Detailed Description section.

The accompanying Figures depict embodiments of the present technology and are not intended to be limiting of its scope. The sizes of various depicted elements are not necessarily drawn to scale, and these various elements may be arbitrarily enlarged to improve legibility. Component details may be abstracted in the Figures to exclude details such as position of components and certain precise connections between such components when such details are unnecessary for a complete understanding of how to make and use the invention.

Many of the details, dimensions, angles and other features shown in the Figures are merely illustrative of particular embodiments of the disclosure. Accordingly, other embodiments can have other details, dimensions, angles and features without departing from the spirit or scope of the present invention. In addition, those of ordinary skill in the art will appreciate that further embodiments of the invention can be practiced without several of the details described below.

In the Figures, identical reference numbers identify identical, or at least generally similar, elements. To facilitate the discussion of any particular element, the most significant digit or digits of any reference number refers to the Figure in which that element is first introduced. For example, element 110 is first introduced and discussed with reference to FIG. 1.

FIG. 1A is a partially exploded isometric view of a thermal management apparatus (e.g., a cooling system 110) for use with a processing module 100, and FIG. 1B is an isometric view of a bracket 114 of the cooling system 110 positioned on the processing module 100. Referring first to FIG. 1A, by way of example the processing module 100 can be a graphics card having a processing device 102 mounted to a substrate 104. As is known, the processing device 102 is typically a graphics processing unit (GPU), and the substrate 104 is typically a printed circuit board (PCB) that provides the necessary circuity, connectors and other electrical components necessary for operation of the graphics card in the resident computer system. For ease of reference, the substrate 104 will be referred to hereinafter as a PCB 104. In the illustrated embodiment, the graphics card may be installed in, for example, various types of mainframe computers, including high performance supercomputers for graphics, rendering, 3D modeling, and virtual reality environments. Those of ordinary skill in the art will appreciate, however, that although a graphics card is described herein for purposes of illustration, in other embodiments the mounting systems and methods described herein can be used with virtually any other type of processing modules including other types of processing devices, including ASICs, FPGAs (Field-Programmable Gate Arrays), CPUs and other electronic devices and packages. Indeed, it is expected that the hardware mounting systems and methods described herein can be used to mechanically, electrically, optically and/or thermally interface a wide variety of components in an efficient manner. Accordingly, the mounting hardware and methods described herein are not limited to any particular use unless specifically noted.

By way of example, the cooling system 110 is described herein in the context of an aftermarket high performance cooling system that is provided by a vendor to be mounted to the processing device 102 in place of the stock heatsink provided with the processing module 100. In this regard, the cooling system 100 includes a bracket 114 that is configured to operationally support a fan 116, a corresponding fan housing 118, and a cooling apparatus 112. In the illustrated embodiment, the cooling apparatus 112 is a liquid cooled heatsink having a cold plate 113 that defines a lower surface thereof, and a body portion 119 which can house a pump for circulating liquid coolant over the cold plate 113 to operationally absorb heat from the processing device 102. As described in greater detail below, in operation the cold plate 113 is configured to be positioned in contact with an upper surface 103 of the processing device 102, which can include a layer of thermal interface material (TIM), such as thermal grease, for efficient heat transfer from the processing device 102 to the cold plate 113. In addition to the forgoing features, the cooling apparatus 112 also includes a mounting flange 150 having four fastener holes 152 equally spaced around the body portion 119.

In the illustrated embodiment, the bracket 114 includes a number of openings to facilitate cooling of the components mounted to the PCB 104. For example, the bracket 114 includes an opening 130 through which cooling air from the fan 116 can flow onto the PCB 104. Additionally, the bracket 114 includes an opening 122 that accommodates the lower portion of the cooling apparatus 112 so that the cold plate 113 can be positioned on the processing device 102. In the illustrated embodiment, the opening 122 has a generally rectangular (e.g., square) shape defined by four edge portions 123 (identified individually as edge portions 123a-d) that in turn define four corresponding corner portions 125 (identified individually as corner portions 125a-d) therebetween. Additionally, the bracket 114 further includes an upper surface 115 and a lower surface 117, and one or more thermal pads 128 that are bonded or otherwise attached to the lower surface 117. In operation, the thermal pads 128 are configured to contact corresponding electronic devices mounted to the PCB 104 and absorb heat therefrom.

To mount the cooling system 110 to the processing module 100 in accordance with conventional methods, the bracket 114 is positioned on the PCB 104 so that the processing device 102 is generally centered within the opening 122. Next, a plurality of fasteners 108 (e.g., screws) are inserted through corresponding fastener holes 120 (identified individually as fastener holes 120a-d) in the PCB 104 and are threaded into corresponding inserts 106 (identified individually as threaded inserts 106a-d). The fasteners 108 are then tightened to adequately secure the bracket 114 to the PCB 104. It should be noted that the numbers and locations of the fasteners 108 are provided by way of example only are merely representative of typical installations; other embodiments may have more or fewer fasteners in other locations. Once the bracket 114 has been secured to the PCB 104, the lower portion of the cooling apparatus 112 can be inserted through the opening 122, and the cooling apparatus 112 can be secured to the bracket 114 by a plurality of fasteners 124 (e.g., screws) that extend through the mounting holes 124 and engage corresponding threaded spacers 126.

In the present example, the cooling system 110 is an aftermarket high performance cooling system that is advertised as being compatible with the processing module 100 and relatively easy to install. In practice, however, the inventors have found that in many cases these “off-the-shelf” cooling systems are not readily compatible with the advertised graphics cards or other processing modules. As a result, these systems are either unusable or require extensive modification to be made to work. For example, in many cases the threaded inserts 106 provided on the bracket 114 are not properly aligned with the corresponding fastener holes 120 in the PCB 104, as shown by reference to the misalignment between the fastener holes 120a and 120c and the threaded inserts 106a and 106c, respectively, in FIG. 1A. This misalignment prevents the bracket 114 from being properly attached to the PCB 104 at all of the provided attachment points.

Other fit issues that can arise with the bracket 114 include mislocated openings. For example, in some instances the fan opening 130 is mislocated so that an edge portion 132 of the opening will interfere with adjacent PCB hardware when the user attempts to properly position the bracket 114 on the PCB 104. A further issue that is often experienced with such cooling systems is that, even if the bracket 114 can be attached to the PCB 104 using some of the provided fastener holes, the opening 122 for the cooling apparatus 112 is often mislocated relative to the processing device 102. As a result, one or more of the edge portions 123 of the opening 122 overhang or otherwise prevent access to fastener holes 134 (identified as fastener holes 134a-d) in the PCB 104, as shown in FIG. 1B. This misalignment prevents the fastener holes 134 from being used to attach, for example, a heatsink to the processing device 102, or to attach other hardware to the PCB at these locations.

A further complication that can arise from the inability to properly secure the bracket 114 to the PCB 104 is that flexing of the bracket 114 and/or the PCB 104 can make it difficult to control a vertical distance D between the upper surface 103 of the processing device 102 and the upper surface 115 of the bracket 114. Controlling the distance D can be further complicated by the stack up of manufacturing tolerances of the device package, the PCB 104, the bracket 104, and the associated hardware. Controlling the distance D, however, can be very important to ensure that when the cooling apparatus 112 is subsequently mounted to the bracket 114, the cold plate 113 will exert a desired pressure (e.g., 40 PSI to 60 PSI) against the TIM and provide optimum cooling of the processing device 102. Flexing or distortion of the PCB 104 due to improper mounting of the bracket 114 can also reduce operational performance of the processing device 102 and complicate or compromise the electrical connection of the PCB 104 to associated electrical interfaces. As the forgoing discussion illustrates, some “off-the-shelf” cooling systems are not readily “compatible” with third party processing modules, notwithstanding the manufacturers claims to the contrary.

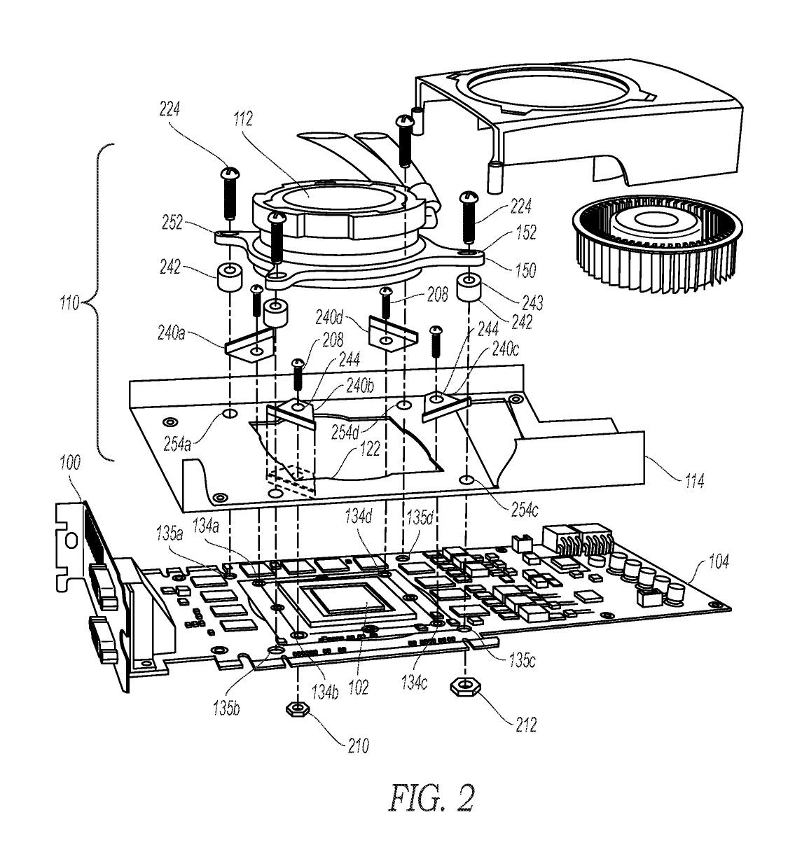

FIG. 2 is a partially exploded isometric view of the cooling system 110 with a plurality of adapters 240 (identified individually as adapters 240a-d) configured in accordance with an embodiment of the present technology. In illustrated embodiment, the processing module 100, the bracket 114 and the cooling apparatus 112 remain unchanged from FIG. 1A, but the original mounting hardware provided by the cooling system manufacturer (e.g., the fasteners 108, the fasteners 124, and the threaded spacers 126) has been replaced by a mounting system that includes the adapters 240 and a plurality of spacers 242. As described in greater detail below, each of the adapters 240 includes a through-hole 244 that receives a fastener 208 (e.g., a screw) that extends through a corresponding hole 134 in the PCB 104 and engages a nut 210. The cooling apparatus 112 is mounted to the bracket 114 by a plurality of fasteners 224 (e.g., screws) that extend through the holes 152 in the mounting flange 150. From the mounting flange 150, each of the fasteners 224 extends through a hole 243 in a spacer 242, a hole 254 in the bracket 114 (identified individually as fastener holes 254a-d), and through a corresponding hole 135 in the PCB 104 (identified individually as fastener holes 135a-d) before engaging a nut 212. It should be noted that, in some embodiments, the fastener holes 134 and 135 are preexisting holes provided in the PCB 104, and the fastener holes 254 in the bracket 114 are also preexisting and simply made larger by removing (e.g., unscrewing) the threaded spacers 126 (FIG. 1A) that came with the bracket 114.

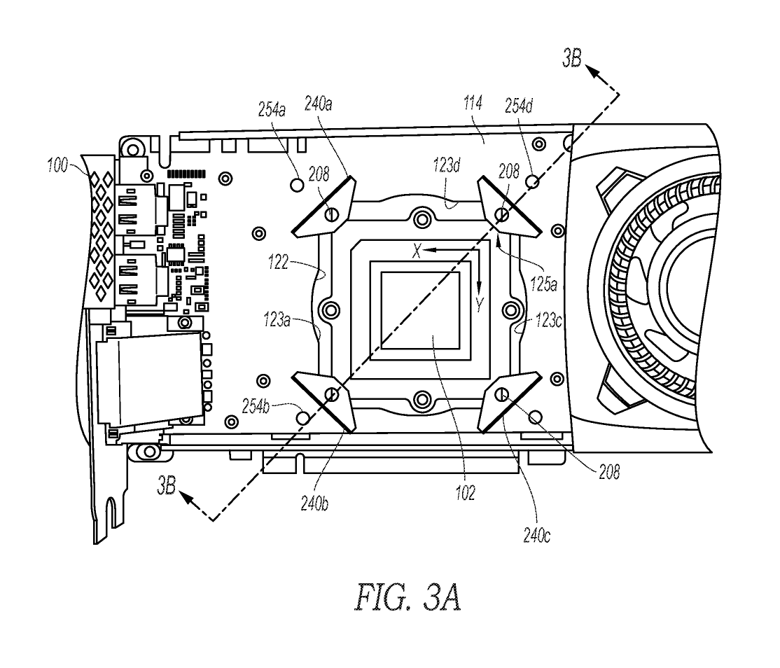

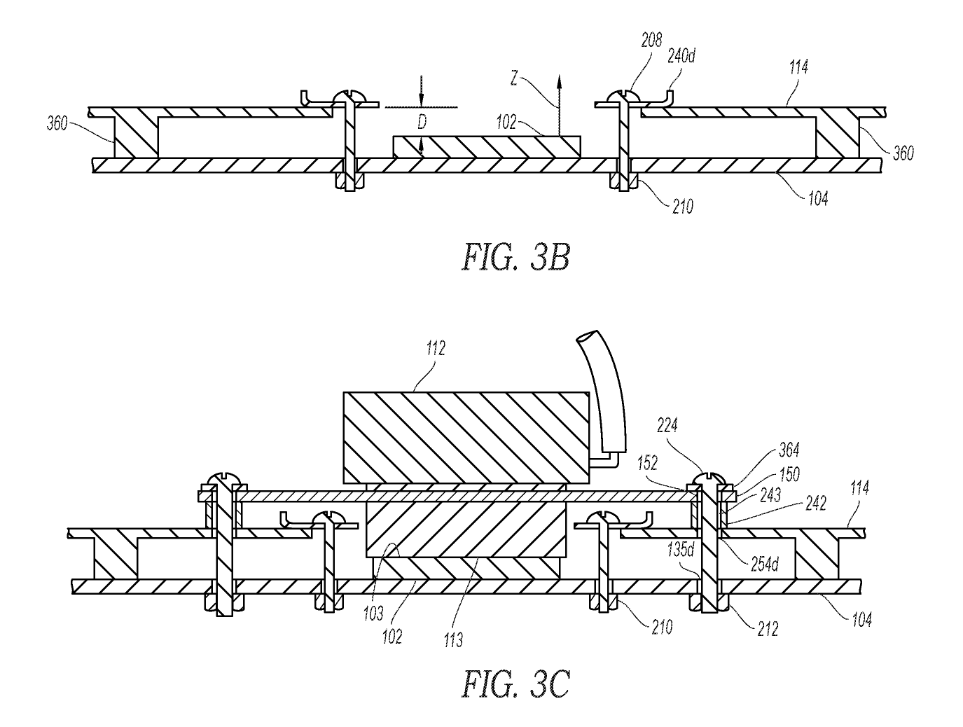

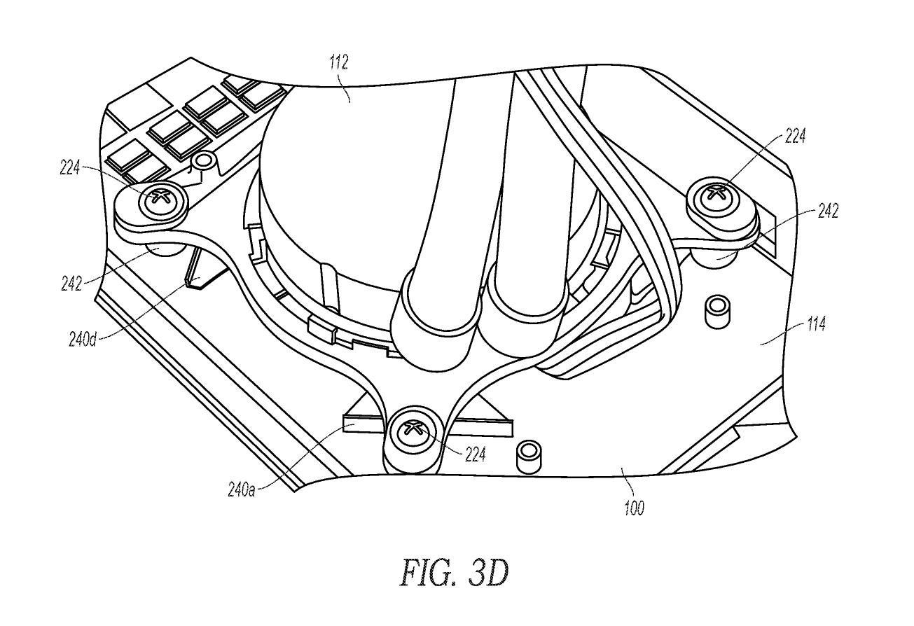

FIG. 3A is a top view of the bracket 114 mounted to the PCB 104 in accordance with an embodiment of the present technology, and FIG. 3B is a cross-sectional view taken substantially along line 3B-3B and FIG. 3A. Referring to FIG. 2 together with FIGS. 3A and 3B, to attach the bracket 114 to the PCB 104, the bracket 114 is positioned on the PCB 104 so that the processing device 102 is aligned (e.g., centered) with respect to the opening 122 in the bracket 114. The bracket 114 can include a plurality of standoffs 360 or other features for properly spacing the bracket 114 above the PCB 104 and the Z direction. Once the bracket 114 has been properly aligned, each of the adapters 240 is positioned so that the fastener hole 244 is positioned over a corner portion 125 of the opening 122 (FIG. 1A), and a fastener 208 is inserted through the fastener hole 244, through the corresponding fastener hole 134 in the PCB 104, and threadably engaged with a nut 210, as shown in FIG. 3A. In the illustrated embodiment, each of the adapters 240 is positioned so that it bridges across the respective corner portion 125 from one edge portion 123 of the opening 122 to the adjacent edge portion 123. As a result, the adapters 240 can press against the bracket 114 to hold it in position, but they enable the position of the bracket 114 to be laterally adjusted in the X and Y directions and “fine-tuned” as needed prior to final tightening of the fasteners 208 to secure the bracket 114 to the PCB 104 in the desired location.

Referring next to FIG. 3C, once the bracket 114 has been properly mounted to the PCB 104, the lower portion of the cooling apparatus 112 can be inserted through the opening 122 so that the cold plate 113 contacts the upper surface 103 of the processing device 102 (and/or any TIM placed thereon) with even pressure. Next, the spacers 242 are positioned under the mounting flange 150 of the cooling apparatus 112, and the fasteners 224 are inserted through the fastener holes 152, the spacer holes 243, and the corresponding fastener holes 254 in the bracket 114. From there, the fasteners 224 extend through the corresponding fastener holes 135 in the PCB 104 and threadably engage the nuts 212. It should be noted that, in some embodiments, the fastener holes 152 in the cooling apparatus mounting flange 150 and the through holes 243 in the spacers 242 are oversized relative to the cross-sectional diameter of the fastener 224 and, as a result, the lateral position of the cooling apparatus 112 in the X or Y directions (FIG. 3A) can be adjusted slightly before final tightening of the fastener 224. In this regard, an oversize washer 364 can be provided under the head of the fastener 224 to facilitate this adjustment.

FIG. 3D illustrates the arrangement of the cooling apparatus 112 relative to the adapters 240 after the cooling apparatus 112 has been fully installed on the processing module 100. As FIGS. 3C and 3D illustrate, the adapters 240 are mounted inboard of with clearance from the fasteners 224 and the spacers 242 for mounting the cooling apparatus 112. As a result, the adapters 240 properly secure the bracket 214 to the PCB 104 without interfering with any portion of the cooling apparatus 112, the bracket 214, or the processing device 102.

Various embodiments of the adapters 240 and associated hardware described herein can overcome the shortcomings of prior art cooling system mounting hardware. For example, as shown in FIGS. 3A and 3B, use of the adapters 240 enables the bracket 114 to be moved laterally in the X and Y directions to properly position the opening 122 and/or other features of the bracket 114 relative to the processing device 102 and/or other features of the PCB 104 prior to final tightening of the fasteners 208. This feature enables the “off-the-shelf” bracket 114 and cooling apparatus 112 to be easily mounted to the processing module 100, even if the original mounting holes and/or other features of the bracket 114 provided by the manufacturer are mislocated. A further advantage of the brackets 240 is that the tension in the fastener 208 can be used to control the pressure exerted against the processing device 103 by the cold plate 113. More specifically, if greater pressure is desired, the respective fasteners 208 can be tightened. Conversely, if less pressure in a particular location is required, the corresponding fastener 208 can be loosened. Additionally, as described above with reference to FIG. 3, by providing oversize through holes in the mounting flange 150 of the cooling apparatus 112, the spacers 242, and the bracket 114, the lateral position of the cooling apparatus 112 can also be adjusted in the X and Y directions prior to final tightening of the fasteners 224.

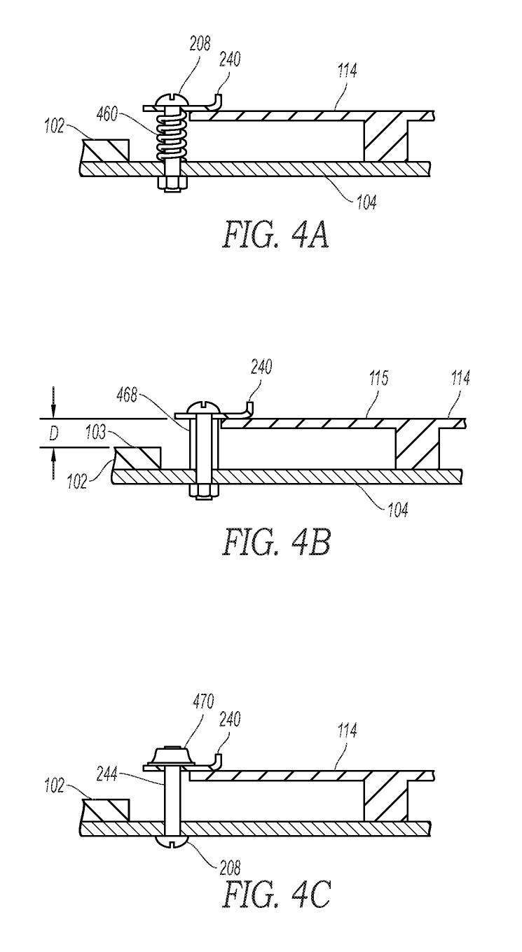

FIGS. 4A-C are a series of cross-sectional views similar to FIG. 3B for the purpose of illustrating various aspects of the present technology. Referring first to FIG. 4A, in the illustrated embodiment a biasing member, such as a coil string 466 can be positioned around the fastener 208 between the adapter 240 and the PCB 104. In this embodiment, the coil spring 466 can be sized to provide a preset compression force that resists further tightening of the fastener 208 once the desired level of torque has been a[applied to the fastener. Use of the spring 466 at each adapter location can help provide an even clamping force and reduce flex or distortion of the bracket 114 around the opening 122. Turning next to FIG. 4B, in another embodiment a spacer 468 can be provided between the adapter 240 and the PCB 104 as a means for controlling the distance D between the upper surface 115 of the bracket 114 and the upper surface 103 of the processing device 102.

Although various embodiments of the adapters 240 can include through holes, such as the fastener holes 244, in other embodiments the adapters 240 can include threaded fastener holes that are configured to receive and threadably engage, for example, the screw 208 when the screw 208 is inserted from the backside from the PCB 104. Additionally, as shown in FIG. 4C, in other embodiments a nut plate 470 can be attached to the upper surface of the adapter 240. In this embodiment, the fastener 208 is inserted through the backside of the PCB 104 and threadably engages the nut plate 470 to operably couple the adapter 240 to the PCB 104. The nut plate 470 can be a floating nut plate or a fixed nut plate. One potential benefit of inserting the fastener 208 from the backside of the PCB as shown in FIG. 4C, is that it can enable the user to adjust the compression load applied to the processing device 102 from the cold plate 113 by means of the fasteners 208 after the cooling apparatus 112 has been installed.

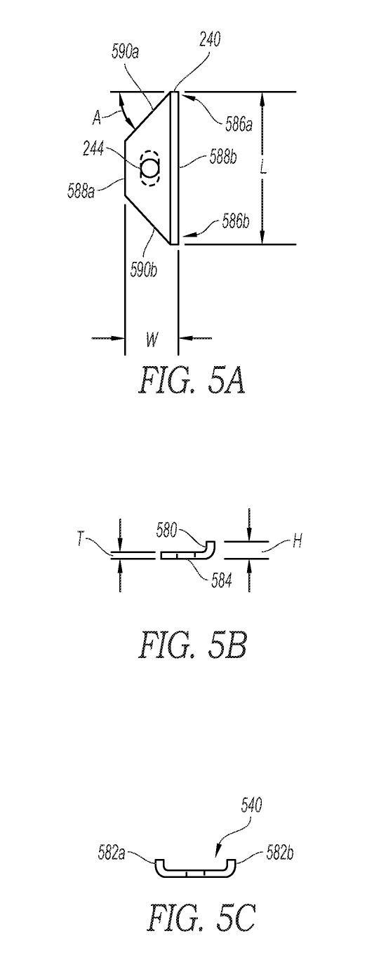

FIGS. 5A and 5C are top and side views, respectively, of the adapter 240 configured in accordance with an embodiment of the present technology, and FIG. 5C is a side view of an adapter 540 configured in accordance with another embodiment of the present technology. Referring first to FIGS. 5A and 5B, the adapter 240 has a planar base portion 584 with a first end portion 586a spaced apart from a second end portion 586b. In the illustrated embodiment, the base portion 584 has a generally trapezoidal shape defined by a first edge portion 588a opposite a second edge portion 588b, and a third edge portion 590a opposite a fourth edge portion 590b. The third and fourth edge portions 590 of the adapter 240 can be beveled or otherwise oriented at an angle A relative to the second edge portion 588b. By way of example only, the angle A can be between about 20 degrees and about 60 degrees or more, or about 45 degrees. In other embodiments, the angle A at one or both of the end portions 586 can be omitted and the respective end portion can be square. In some embodiments, the adapter 240 can have a length L of from about 0.5 inch to about 1.5 inches, or about 1 inch, and a width W of from about 0.25 inch to about 1 inch, or about 0.5 inch. These dimensions are provided by way of example only, and adapters configured in accordance with the present technology can have other lengths and/or widths without departing from the present disclosure. The foregoing dimensions have shown to be useful for some mounting applications in which the adapter 240 bridges across a 90 degree corner of an opening and some X, Y and Z adjustment of the respective parts is desirable. However, it should be understood that adapters configured in accordance with the present technology need not have a trapezoidal shape, and other embodiments can have a wide variety of beneficial shapes including, for example, generally rectangular shapes, parallelograms, curved or partially curved shapes, etc.

In a further aspect of this embodiment, the adapter 240 includes a lip or flange 580 extending upwardly from the planar base portion 584 along the second edge portion 588b. In some embodiments, the flange 580 can have a height H of from about 0.04 inch to about 0.25 inch, or about 0.06 inch, and is provided to enhance the bending stiffness and, accordingly, reduce flex of the adapter 240. In other embodiments, the flange 580 can be omitted, or as shown in FIG. 5C, the adapter 540 can include upstanding flanges 582a and 582b on two or more edge portions. The fastener hole 244 can be round, elongated, or oversize in various embodiments. Elongating the fastener hole 244 in either the length or width directions, and/or making the hole 244 oversize relative to the diameter of the fastener 208 (FIG. 2) can facilitate X-Y positional adjustment of the adapter 240 during installation but may require the addition of a washer (not shown) under the head of the fastener.

Depending on the particular application, the underside of the planar base portion 584 of the bracket 240 can include various surface features or treatments to facilitate alignment during the assembly process. For example, such features can include ridges, ribs (e.g., orthogonal ribs), serrations, scalloped surfaces, etc. to enhance alignment and/or grip. Surface treatments can include, for example, adhesives, tailored surface energy, magnetic materials, etc. to increase or decrease the mating surface stiction or static friction. These features and treatments may be location specific or generalized over the entire area of the bracket 240.

Although various embodiments of adapters have been described herein in the context of adapters for mounting a cooling solution (e.g., a liquid cooling solution) to a graphics card or other processing module, the adapters described herein and configured in accordance with embodiments of the present technology can be used in a wide variety of applications without departing from the present disclosure. For example, it is expected that embodiments of the adapters described herein can be used to mechanically, electrically, and/or optically interface cooperating components with, for example, multi-chip module (MCM) or Chip-on-Wafer-on-Substrate (CoWoS) device packages when the components are designed to operate as a system and the mechanical interface has a tolerant stack up that necessitates the use of the adjustable adapters described herein. In addition to positioning cooling systems, various embodiments of the adapters described herein can also be used to position other devices relative to processing devices in a computer system, such as positioning optical devices relative to photonic packages. Moreover, although various embodiments have been described in the context of adapters that bridge across a 90-degree corner of an opening, the adapters described herein and various embodiments thereof can be used to also bridge across opposite edge portions of an opening, and/or between two edges that are oriented at angles different than 90 degrees. Accordingly, the structures, systems and methods described herein are not limited to the particular embodiments described above.

The adapter 240 can be manufactured from a wide variety of suitable materials and methods known to those of ordinary skill in the art. For example, in some embodiments the adapter 240 can be formed (e.g. stamped or machined) from a suitable steel, such as stainless steel sheet, having a thickness T of from about 0.04 inch to about 0.1 inch, or about 0.06 inch. In other embodiments, the adapter 240 can be formed from other metals, such as aluminum, as well as other non-metallic materials such as composites and high-strength polymers. Additionally, in some embodiments it may be advantageous to form the adapter 240 from an electrically conductive material to enhance electrical grounding in some applications, or to form the adapter 240 from a thermally insulative or conductive material to either enhance or reduce thermal conduction, as the case may be.

Although the structure 240 is referred to herein as an “adapter” for ease of reference, it should be appreciated that adapter 240 can also be referred to as a bracket, fitting, clip, or other structure without departing from the present disclosure. Additionally, although embodiments described above relate to mounting brackets for cooling systems, the adapters described herein can also be used to position and/or mount a wide variety of other devices and structures relative to each other. For example, in some embodiments the adapters described herein can be used to mechanically, thermally, electrically, and/or optically position devices relative to each other in 3D (stacked-die) integrated circuit packages, 3D photonic integrated circuits, etc., especially in applications where tolerance stack-ups may lead to variable spacing between critical components.

References throughout the foregoing description to features, advantages, or similar language do not imply that all of the features and advantages that may be realized with the present technology should be or are in any single embodiment of the invention. Rather, language referring to the features and advantages is understood to mean that a specific feature, advantage, or characteristic described in connection with an embodiment is included in at least one embodiment of the present technology. Thus, discussion of the features and advantages, and similar language, throughout this specification may, but do not necessarily, refer to the same embodiment.

Furthermore, the described features, advantages, and characteristics of the present technology may be combined in any suitable manner in one or more embodiments. One skilled in the relevant art will recognize that the present technology can be practiced without one or more of the specific features or advantages of a particular embodiment. In other instances, additional features and advantages may be recognized in certain embodiments that may not be present in all embodiments of the present technology.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples and embodiments of the invention is not intended to be exhaustive or to limit the invention to the precise form disclosed above. While specific examples for the invention are described above for illustrative purposes, various equivalent modifications are possible within the scope of the invention, as those skilled in the relevant art will recognize.

The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements. Further any specific numbers noted herein are only examples: alternative implementations may employ differing values or ranges.

While the above description describes various embodiments of the invention and the best mode contemplated, regardless how detailed the above text, the invention can be practiced in many ways. Details of the system may vary considerably in its specific implementation, while still being encompassed by the present disclosure. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

From the foregoing, it will be appreciated that specific embodiments of the invention have been described herein for purposes of illustration, but that various modifications may be made without deviating from the spirit and scope of the various embodiments of the invention. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims.

Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

1. A system for mounting a thermal management apparatus to a processing device on a printed circuit board (PCB), the system comprising:
a bracket configured to support the thermal management apparatus, wherein the bracket has an upper surface facing away from the PCB and a lower surface facing toward the PCB, wherein the bracket further includes an opening extending through the upper and lower surfaces, and wherein the opening is configured to receive a portion of the thermal management apparatus extending therethrough to contact the processing device and absorb heat therefrom;
an adapter positioned adjacent to the upper surface of the bracket proximate an edge portion of the opening; and
a fastener operably extending through a fastener hole in the adapter, through the opening in the bracket, and through a fastener hole in the PCB to operably secure the bracket to the PCB with the opening in alignment with the processing device.

2. The system of claim 1 wherein the adapter allows the bracket to be moved in one or more directions parallel to the PCB to adjust the lateral position of the opening relative to the processing device prior to securing the bracket to the PCB.

3. The system of claim 1 wherein the edge portion of the opening in the bracket is a first edge portion, wherein the opening includes a second edge portion adjacent to the first edge portion and defining a corner portion therebetween, wherein the fastener extends through the opening proximate the corner portion, and wherein the adapter bridges across the corner portion of the opening from first edge portion to the second edge portion.

4. The system of claim 1 wherein the adapter is a first adapter, the fastener is a first fastener, the edge portion is a first edge portion, and the fastener hole in the PCB is a first fastener hole in the PCB, and wherein the system further comprises:
a second adapter operably positioned adjacent to the upper surface of the bracket proximate a second edge portion of the opening; and
a second fastener, wherein the second fastener operably extends through a fastener hole in the second adapter, through the opening in the bracket, and through a second fastener hole in the PCB so that the second adapter cooperates with the first adapter to operably secure the bracket to the PCB.

5. The system of claim 4 wherein the lengths of the first and second fasteners can be adjusted to control the vertical position of the opening relative to the processing device prior to securing the bracket to the PCB.

6. The system of claim 4 wherein the first and second adapters are substantially identical.

7. The system of claim 4 wherein the opening in the bracket has a first corner portion defined by the first edge portion and a third edge portion, and a second corner portion defined by the second edge portion and a fourth edge portion opposite the third edge portion, wherein the first adapter bridges across the first corner portion from first edge portion to the third edge portion, and wherein the second adapter bridges across the second corner portion from the second edge portion to the fourth edge portion.

8. The system of claim 4, further comprising:
the thermal management apparatus, wherein the thermal management apparatus includes a mounting portion having at least first and second fastener holes;
a third fastener extending through the first fastener hole in the mounting portion and a first fastener hole in the bracket;
a fourth fastener extending through the second fastener hole in the mounting portion and a second fastener hole in the bracket, wherein the third and fourth fasteners at least partially attach the thermal management apparatus to the bracket, and wherein the first and second adapters are positioned between the mounting portion and the bracket.

9. The system of claim 4, further comprising:
the thermal management apparatus, wherein the thermal management apparatus includes a mounting portion having at least first and second fastener holes;
a third fastener extending through the first fastener hole in the mounting portion and a first fastener hole in the bracket;
a fourth fastener extending through the second fastener hole in the mounting portion and a second fastener hole in the bracket, wherein the third and fourth fasteners at least partially attach the thermal management apparatus to the bracket, wherein the first adapter is positioned between the first fastener hole in the bracket and the opening, and wherein the second adapter is positioned between the second fastener hole in the bracket and the opening.

10. The system of claim 4 wherein the processing device includes an upper surface, and wherein the system further comprises:
the thermal management apparatus, wherein the thermal management apparatus is mounted to the bracket so that a portion of the thermal management apparatus extends through the opening and applies pressure to the upper surface of the processing device to absorb heat therefrom, and
wherein the lengths of the first and second fasteners can be adjusted to control the pressure applied to the processing device by the thermal management apparatus.

11-21. (canceled)
